(19) United States
(12) Patent Application Publication
(10) Pub. No.: US 2017/0024477 A1
(43) Pub. Date: Jan. 26, 2017

(54) SERVER AND METHOD FOR PROVIDING CONTENT ITEMS BASED ON EXECUTIONS OF APPLICATIONS

(71) Applicant: Doat Media Ltd., TEL AVIV (IL)

(72) Inventor: Rami KASTERSTEIN, Givatayim (IL)

(73) Assignee: Doat Media Ltd., TEL AVIV (IL)

(21) Appl. No.: 15/200,248

(22) Filed: Jul. 1, 2016

Related U.S. Application Data
(63) Continuation-in-part of application No. 14/955,831, filed on Dec. 1, 2015.
Application No. 14/955,831 is a continuation-in-part of application No. 14/850,200, filed on Sep. 10, 2015.
Application No. 14/850,200 is a continuation of application No. 13/712,563, filed on Dec. 12, 2012, now Pat. No. 9,141,702.
Application No. 13/712,563 is a continuation-in-part of application No. 13/156,999, filed on Jun. 9, 2011, now Pat. No. 9,323,844.
Application No. 13/712,563 is a continuation-in-part of application No. 13/296,619, filed on Nov. 15, 2011.
Application No. 14/955,831 is a continuation-in-part of application No. 14/583,310, filed on Dec. 26, 2014.
Application No. 14/583,310 is a continuation-in-part of application No. 13/712,563, filed on Dec. 12, 2012, now Pat. No. 9,141,702.
(60) Provisional application No. 62/187,273, filed on Jul. 1, 2015.
(60) Provisional application No. 62/086,728, filed on Dec. 3, 2014.
(60) Provisional application No. 61/468,095, filed on Mar. 28, 2011.
(60) Provisional application No. 61/354,022, filed on Jun. 11, 2010.
(60) Provisional application No. 61/920,784, filed on Dec. 26, 2013.

(51) Int. Cl. G06F 17/30

(52) U.S. Cl. CPC G06F 17/30867; G06F 17/30554; G06F 17/30389

(57) ABSTRACT

A server and method for providing content based on executions of applications. The method includes identifying a request to execute an application on a user device; determining, based at least in part on the identified request, a user intent of a user of the user device; querying, based on the user intent, at least one data source; selecting, based on a response from the at least one data source, at least one content item for display on the user device; and sending, to the user device, the selected at least one content item.

### CROSS-REFERENCE TO RELATED APPLICATIONS

This application claims the benefit of U.S. Provisional Application No. 62/187,273 filed on Jul. 1, 2015, the contents of which are hereby incorporated by reference. This application is also a continuation-in-part of U.S. patent application Ser. No. 14/955,831 filed on Dec. 1, 2015, now pending, which claims the benefit of U.S. Provisional Application No. 62/086,728 filed on Dec. 3, 2014. The 14/955,831 Application is a continuation-in-part of:

(a) U.S. patent application Ser. No. 14/850,200 filed on Sep. 10, 2015, now pending which is a continuation of U.S. patent application Ser. No. 13/712,563 filed on Dec. 12, 2012, now U.S. Pat. No. 9,141,702. The 13/712,563 Application is a continuation-in-part of: (I) U.S. patent application Ser. No. 13/156,999 filed on Jun. 9, 2011, now U.S. Pat. No. 9,323,844, which claims the benefit of U.S. Provisional Patent Application No. 61/468,095 filed on Mar. 28, 2011, and U.S. Provisional Patent Application No. 61/354,022, filed on Jun. 11, 2010; and (II) U.S. patent application Ser. No. 13/296,619 filed on Nov. 15, 2011, now pending; and

(b) U.S. patent application Ser. No. 14/583,310 filed on Dec. 26, 2014, now pending. The 14/583,310 Application claims the benefit of U.S. Provisional Patent Application No. 61/920,784 filed on Dec. 26, 2013. The 14/583,310 Application is also a continuation-in-part of the above-mentioned 13/712,563 Application.

The contents of the above-referenced applications are hereby incorporated by reference.

### TECHNICAL FIELD

The present disclosure relates generally to displaying content on user devices, and more particularly to displaying content on user devices based on execution of applications.

### BACKGROUND

The use of mobile devices such as smart phones, mobile phones, tablet computers, and other similar devices, has significantly increased in past years. Mobile devices allow access to a variety of application programs also known as “applications” or “apps.” The applications are usually designed to help a user of a mobile device to perform a specific task. Applications may be bundled with the computer and its system software, or may be accessible, and sometimes downloadable, from a central repository.

Through the central repositories, users can download applications for virtually any purpose, limited only by the amount of memory available on the users' phones. Applications exist for social media, finance, news, entertainment, gaming, and more. Some applications serve multiple purposes or otherwise offer multiple types of content.

Due to the widespread availability of these applications, users may become overwhelmed by the large number of available choices of applications to use. As a result, use of particular features of applications or entire applications may decrease. More specifically, applications which do not usually offer content that is desirable to the user may fall out of favor and, thus, see decreased usage. Consequently, such particular features or entire applications that are infrequently used may be ignored or deleted by users.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The embodiments disclosed herein include a method for providing content based on executions of applications. The method includes identifying a request to execute an application on a user device; determining, based at least in part on the identified request, a user intent of a user of the user device; querying, based on the user intent, at least one data source; selecting, based on a response from the at least one data source, at least one content item for display on the user device; and sending, to the user device, the selected at least one content item.

The embodiments disclosed herein also include a server for providing content based on executions of applications. The server includes a processing system; and a memory, the memory containing instructions that, when executed by the processing system, configure the server to: identify a request to execute an application on a user device; determine, based at least in part on the identified request, a user intent of a user of the user device; querying, based on the user intent, at least one data source; select, based on a response from the at least one data source, at least one content item for display on the user device; and send, to the user device, the selected at least one content item.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a diagram of an agent installed on a user device according to an embodiment.

FIG. 3 is a flowchart illustrating a method for displaying content based on execution of applications according to an embodiment.

FIG. 4 is a flowchart illustrating a method for selecting content for display on a user device according to an embodiment.

FIG. 5 is a schematic diagram of an intent detector according to an embodiment.

FIG. 6 is a flow diagram illustrating generating insights for determining user intent according to an embodiment.

FIG. 7 is a flowchart illustrating a method for determining a user intent according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for displaying content on user devices based on execution of applications. A request to execute an application on a user device is identified. A user intent is determined based in part on the request. Content for display on the user device is selected. The selected content is displayed in proximity to the execution of the requested application.

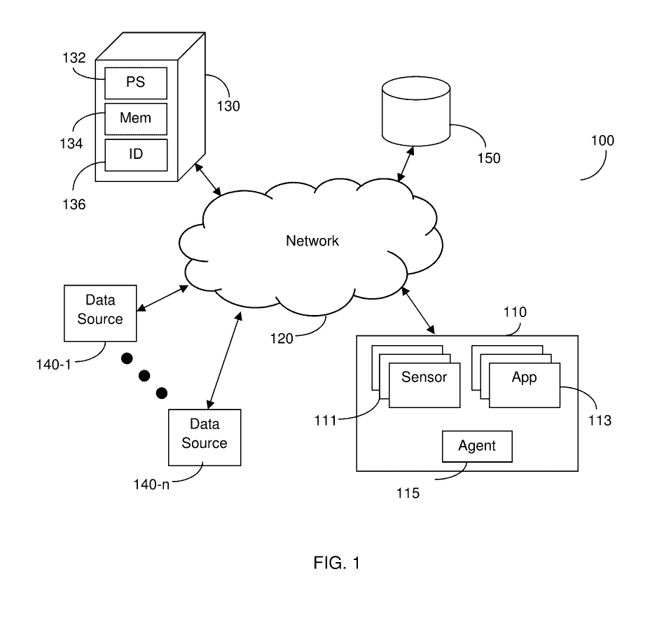

FIG. 1 shows an example network diagram 100 utilized to describe the various disclosed embodiments. The network diagram 100 includes a user device 110, a network 120, a server 130, and a plurality of data sources 140-1 through 140-n (hereinafter referred to individually as a data source 140 and collectively as data source 140, merely for simplicity purposes). In some embodiments, the network diagram 100 further includes a database 150. In some embodiments, the database 150 includes a plurality of user intents, variables, selected content items for display on user devices, or a combination thereof.

The user device 110 may be, but is not limited to, a smart phone, a mobile phone, a laptop, a tablet computer, a wearable computing device, a personal computer (PC), a smart television, and the like. The network 120 may be, but is not limited to, a local area network (LAN), a wide area network (WAN), a metro area network (MAN), the world wide web (WWW), the Internet, a wired network, a wireless network, similar networks, and the like, as well as any combination thereof. Each of the data sources 140 may be, but is not limited to, a web search engine, a server of a content provider, a vertical comparison engine, a server of a content publisher, and the like. In a particular embodiment, any of the data sources 140 may be an advertisement server including advertising content for display based on execution of applications or features of applications.

The user device 110 may execute or have installed therein, but is not limited to, one or more sensors 111, one or more applications (apps) 113, and an agent 115. The sensors 111 may be, but are not limited to, a microphone, a clock, a global positioning system, a camera, and the like. The applications 113 executed or accessed through the client device 110 may include, but are not limited to, a mobile application, a virtual application, a web application, a native application, and the like. The agent 115 may be an application installed on the user device 110 for collecting data related to user intent and to send such data to, e.g., the server 130. In another embodiment, the agent 115 may be configured to determine user intent based on the collected data, to query for content items based on the determined user intent, and to select content items for display on the user device 110 from among the queried content items.

To this end, the user device 110 is configured to collect variables associated with a user of the user device 110. The collected variables may be, but are not limited to, environmental variables, personal variables, queries, or a combination thereof. Environmental variables are typically based on and represent signals over which users have no direct control such as, for example, time of day, location, motion information, weather information, sounds, images, and so on. Personal variables are typically based on and represent signals over which users have direct control such as, for example, applications executed on the user device 110, actions taken by the user device 110, and so on. The queries may be, but are not limited to, queries provided to the user device 110 (e.g., textual queries, selection of a button associated with a query, etc.). The signals may be collected by the user device 110 using one or more of the sensors 111.

The collected variables may be sent by the user device 110 to the server 130 over the network 120. In an embodiment, the server 130 includes an intent detector 136 utilized to generate insights into user intents. The server 130 is configured to determine a user intent via the intent detector 136 based on the collected variables. In a further embodiment, the server 130 is configured to determine the user intent upon identifying a request to execute an application or a particular feature of an application. The user intent represents the type of content, the content, actions, or a combination thereof that may be of interest to a user during a current time period. For example, for a current time period in the morning, a user intent may be to read news articles.

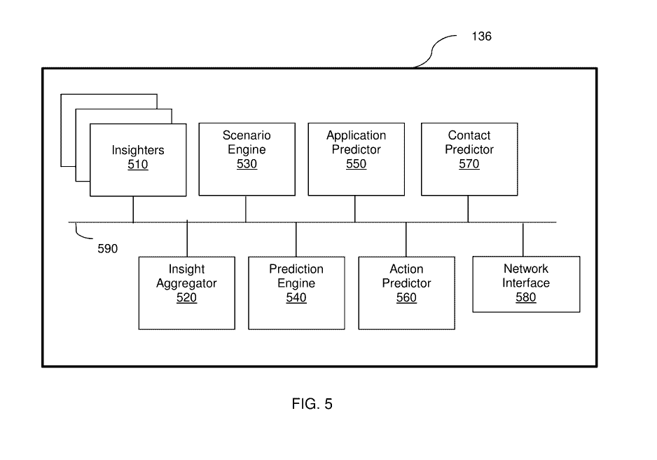

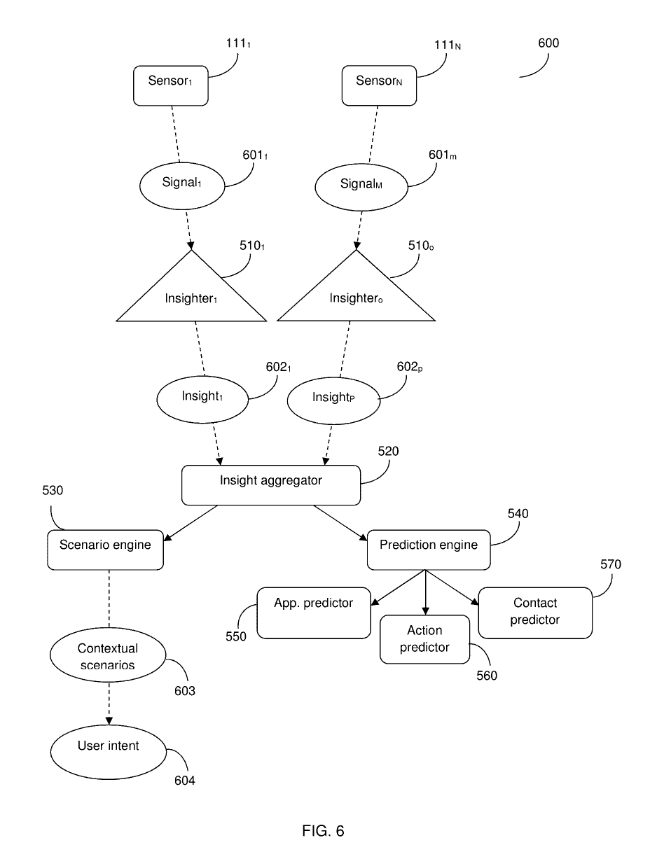

In an embodiment, the intent detector 136 includes a plurality of engines (not shown in FIG. 1), where each engine is configured to analyze collected variables with respect to one or more topics of interest to the engine. Various example engines utilized by an intent detector are described further herein below with respect to FIGS. 5 and 6.

In an example embodiment, the server 130 is configured to identify a request to execute an application or a feature of an application on the user device 110 and to send a query to one or more of the data sources 140. In a further embodiment, the query is based on, but not limited to, the requested application or feature, the variables, or a combination thereof. For example, if a request to execute a heartbeat monitoring application is identified while variables from a motion sensor indicate that the user is running, a query for content related to sports activity (e.g., sports clothing or accessories) or running in particular may be sent by the server 130.

In a further embodiment, the server 130 is configured to determine which of the data sources 140 to send the query based on, for example, registration of the data sources 140 to certain categories such as “music” or “carpentry tools,” registration of the data sources 140 to certain keywords, and the like. Sending queries to appropriate resources based on user intent is described further in U.S. Pat. No. 9,323,844, assigned to the common assignee, which is hereby incorporated by reference.

In an embodiment, the server 130 is configured to receive a response including content from the data source 140 to which the query was sent. The content in the response may include, but is not limited to, links, web sources, multimedia content elements, combinations thereof, and the like. Multimedia content elements may include but are not limited to, images, graphics, videos, combinations thereof, and the like. Based on the received response, the server 130 is configured to select at least one content item from the response for display on the user device 110.

In an embodiment, to identify a confidence that the determined user intent is accurate, the server 130 is configured to verify the user intent. To this end, the server 130 requests the intent detector 136 to determine a user intent based on one or more of the collected variables. Either or both of the server 130 and the intent detector 136 may be configured to store the collected variables in, e.g., the database 150.

It should be noted that the server 130 typically includes a processing system (PS) 132 coupled to a memory (mem) 134. The processing system 132 may comprise or be a component of a processor (not shown) or an array of processors coupled to the memory 134. The memory 134 contains instructions that can be executed by the processing system 132. The instructions, when executed by the processing system 132, cause the processing system 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should also be noted that the intent detector 136 is shown as being included in the server 130 merely for simplicity purposes and without limitation on the disclosed embodiments. The intent detector 136 may be separate from and communicatively connected to the server 130 (e.g., over the network 120) without departing from the scope of the disclosure. In some embodiments, the functionality of the intent detector 136 may be integrated by the agent 115. Thus, in such embodiments, the user is determined to detect the user intent.

It should be understood that the embodiments disclosed herein are not limited to the specific architecture illustrated in FIG. 1, and other architectures may be equally used without departing from the scope of the disclosed embodiments. Specifically, the server 130 may reside in a cloud computing platform, a datacenter, and the like. Moreover, in an embodiment, there may be a plurality of servers operating as described hereinabove and configured to either have one as a standby, to share the load between them, or to split the functions between them.

It should be further noted that the embodiments described herein above with respect to FIG. 1 are described with respect to a single user device 110 having one agent 115 merely for simplicity purposes and without limitation on the disclosed embodiments. Multiple user devices, each equipped with an agent, may be used and actions may be executed respective of contextual scenarios for the user of each user device without departing from the scope of the disclosure.

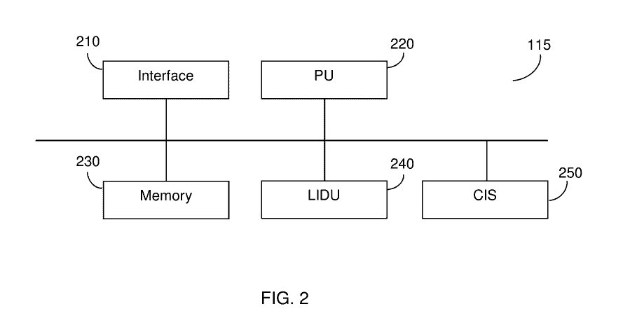

FIG. 2 shows an example diagram of an agent 115 installed on the user device 110.

The agent 115 includes an interface 210, a processing unit (PU) 220, a memory 230, a variable detector 240, and a content item selector (CIS) 250.

The interface 210 allows the agent to receive requests from the user device 110 as well as to send queries to the data sources 140 over the network 120 and to receive responses to such queries from the data sources 140. The memory 230 contains instructions that, when executed by the processing unit 220, configure the agent to 115 to collect variables (e.g., local and environmental variables) relevant to determining user intent via the variable detector 240. The variable detector 240 may be further configured to determine a user intent based on any of an application executed or requested to be executed on the user device 110, a feature of an application executed or requested to be executed on the user device 110, the collected variables, and a combination thereof.

The content item selector 250 may be configured to query a database for content items based on the determined user intent, the requested application or feature, or a combination thereof. The content item selector 250 may be further configured to select one or more content items based on a response to the query and to cause a display of the selected content items on the user device 110.

It should be noted that the embodiments described herein above with respect to FIG. 2 are merely examples and do not limit any of the disclosed embodiments. The user intent may be determined via the server 130 without departing from the scope of the disclosure.

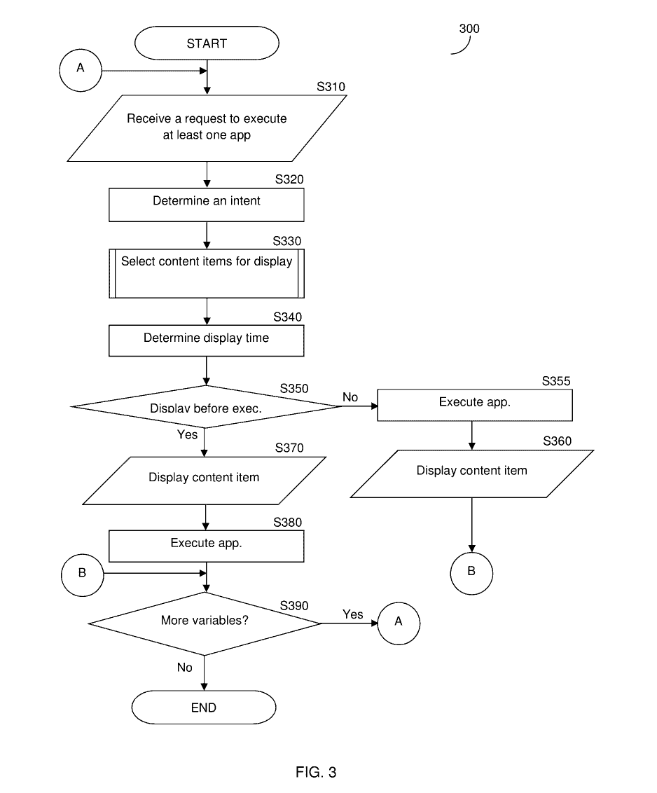

FIG. 3 shows a flowchart 300 illustrating a method for displaying content on a user device based on executions of applications according to an embodiment. In an embodiment, the method may be performed by a server (e.g., the server 130).

At S310, a request to execute an application or a particular feature of an application on a user device is identified. The request may be received by an agent installed on the user device.

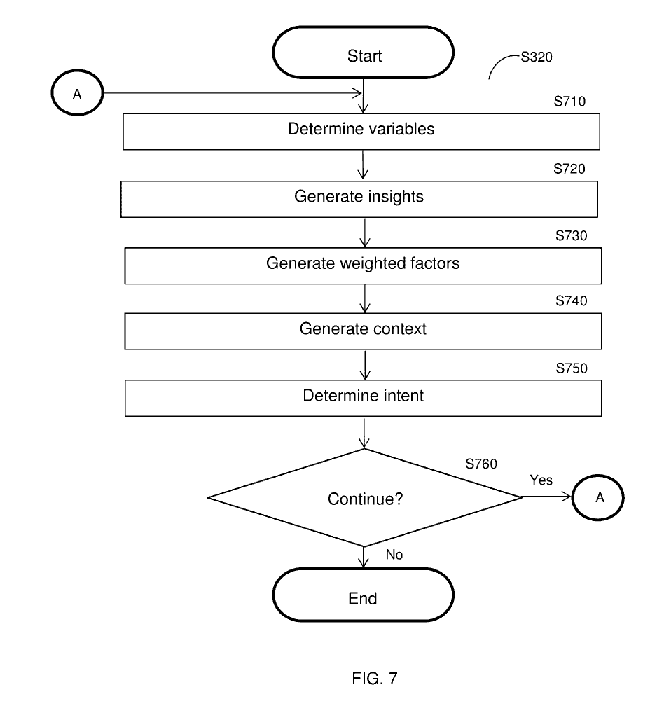

At S320, a user intent of a user of the user device is determined. The user intent may be determined based on, but not limited to, the requested application or feature, variables related to the user device, or a combination thereof. Determining the user intent may further include generating insights based in part on the variables, generating contexts based on the insights, and determining user intent based on the generated context. Determining user intents is described further herein below with respect to FIG. 7.

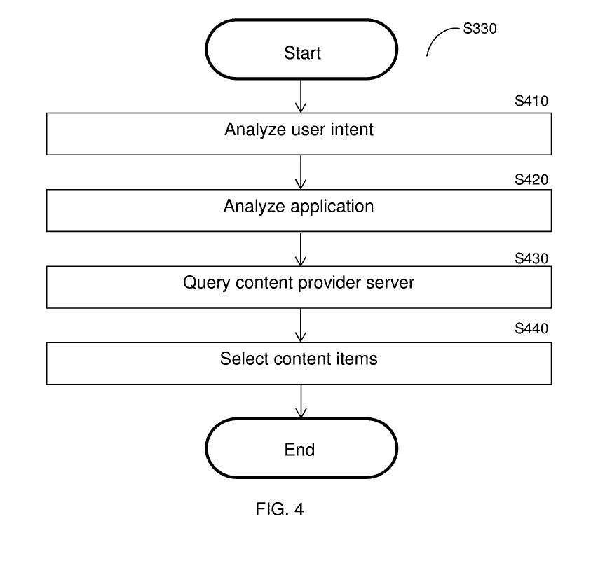

At S330, based on the determined user intent, content items to be displayed on the user device in proximity to execution of the application or feature are selected. Selecting the content items may include querying a data source for content based on the user intent, the requested application or feature, or a combination thereof. The content in the response may include, but is not limited to, links, web sources, multimedia content elements, combinations thereof, and the like. Multimedia content elements may include but are not limited to, images, graphics, videos, combinations thereof, and the like. Selecting the content items may further include receiving content items from the queried data source and selecting one or more of the received content items for display on the user device. Selecting content items for display on user devices is described further herein below with respect to FIG. 4.

At S340, a time pointer for displaying the selected content items is determined. In an embodiment, the time pointer is determined relative to execution of the requested application or feature. In a further embodiment, the time pointer is determined at least in part based on the user intent, the selected content items, or a combination thereof. The time pointer may be a time before execution of the application or feature, a time during execution of the application or feature (e.g., 30 seconds after execution of the application or feature), or a time after execution of the application or feature (e.g., after closing the application or ceasing use of the feature).

In an embodiment, S340 may further include querying a database having information related to a plurality of structured cases, where each structured case is associated with a user intent. The query may be based on, but not limited to, the user intent, the selected content items, a combination thereof, and the like. As an example, when a user opens a fitness application, the user intent may be “exercising” and content items including advertisements for healthy food items may be selected. Based on the “exercising” user intent and the healthy food content items, a database is queried to determine an appropriate time pointer relative to execution of the fitness application. The appropriate time pointer may be determined to be after execution of the fitness application terminates (i.e., when the user is finished exercising and likely intending to eat).

At S350, based on the time pointer, it is determined if the selected content items are to be displayed before execution of the application or feature and, if so, execution continues with S370; otherwise, execution continues with S355.

At S355, the application is executed on the user device and execution continues with

S360. At S360, the selected content items are sent for display on the user device and execution continues with S390.

At S370, when it is determined that the selected content items are to be displayed before execution of the application or feature, the selected content items are caused to be displayed on the user device. At S380, the application is executed on the user device.

At S390, it is checked if additional requests to execute applications or features have been identified and, if so, execution continues with S310; otherwise, execution terminates.

As a non-limiting example, a request to execute a game application on a user device is identified. Variables related to the user device indicate that the user has recently accessed a mobile application on the user device. Based on the variables and the requested game application a user intent of “playing games and using social media” is determined. Based on the user intent, a data source of an advertiser is queried for content related to social media games. Content items including a video advertisement for a game featuring social media functionality (e.g., score sharing, messaging, etc.), are received, and the video advertisement is selected for display on the user device. It is determined that the video advertisement is to be displayed before execution of the game application. Accordingly, the video advertisement is sent for display on the user device and execution of the game application begins immediately after display of the video advertisement.

FIG. 4 shows an example flowchart S330 illustrating a method for selecting content for display on a user device according to an embodiment.

At S410, a user intent of a user of the user device is analyzed. Analyzing the user intent may include identifying a category of user intent. Based on the analysis, potential needs or interests of the user may be determined. As an example, if the user intent is “commuting to work,” potential needs or interests may include travel applications (e.g., applications for planning routes, avoiding traffic, optimizing train or bus schedules, etc.), music, games, news, or combinations thereof.

At S420, the requested application or feature is analyzed. Analyzing the requested application or feature may include determining a type of the application or feature and determining an actual need or interest of the user based on the application or feature and the potential needs or interests. For example, if the user intent is “running,” potential needs or interests may include “exercising” and “escaping danger.” If the user executes a fitness application, the actual need or interest for the user may be determined to be “exercising.” In contrast, if the user initiates a call to 911 (i.e., an emergency service), the actual need or interest may be determined to be “escaping danger.”

At S430, a query is generated and sent based on the analyses of the user intent and the application or feature. The query is for content items related to the user intent and to the application. The query may include, but is not limited to, the user intent, the actual need or interest, and a combination thereof. As an example, for a running user, the query may be either “running +exercise” or “running +emergency.”

At S440, a response to the query is received and at least one content item is selected from among content items in the response. In an embodiment, the selection may be based on one or more selection criteria. In a further embodiment the selection criteria may be based on weighted factors. The selection criteria may include, but are not limited to, a relevance of each content item to the combined user intent and actual need or interest, a size of each content item, a popularity of each content item, economic incentives for utilizing each content item (i.e., bids by advertisers for displaying their respective content items), and the like. In another embodiment, the selection may be random. In yet another embodiment, the selection may be based on an ordered grouping of content items (i.e., a round robin selection).

FIG. 5 is an example schematic diagram illustrating the intent detector 136 according to an embodiment. In an embodiment, the intent detector 136 includes a plurality of insighters 510, an insight aggregator 520, a contextual scenario engine 530, a prediction engine 540, an application predictor 550, an action predictor 560, a contact predictor 570, and an interface 580. In an embodiment, the various engines may be connected via a bus 590.

The insighters 510 are configured to generate insights based on signals (e.g., signals collected by the sensors 111), variables (e.g., variables collected by the user device 110 or the agent 115), or a combination thereof. Each insight relates to one of the variables or signals. The insighters 510 may be further configured to classify the signals and variables and to generate conclusions based thereon. In a further embodiment, the insighters 510 may be further configured to generate weighted factors indicating a confidence level in each insight, i.e., a likelihood that the insight is correct.

The insight aggregator 520 may be configured to differentiate among the insights based on, e.g., commonality of the signals and variables. In a further embodiment, the insight aggregator 520 is configured to identify common behavior patterns based on the differentiation.

The contextual scenario engine 530 is configured to generate contextual scenarios based on the insights generated by the insighters 510 or differentiated by the insight aggregator 520. In an embodiment, the contextual scenarios may be generated using a database (e.g., the database 150) having a plurality of contexts and corresponding insights. Each context represents a current state of the user as demonstrated via the insights. For example, based on variables indicating that a user has searched for cake recipes and has set a timer function, a contextual scenario indicating that the user is baking may be generated. In a further embodiment, the contextual scenario engine 530 is configured to determine a user intent based on the generated contextual scenarios.

The prediction engine 540 is configured to determine predicted future behavior of the user device 110. The predicted behavior may include, but is not limited to, environmental parameters, actions, communications with particular contacts, launching of particular applications, and the like.

In an embodiment, the prediction engine 540 may include or be communicatively connected to an application program predictor (app. predictor) 550, an actions predictor 560, and a contact predictor 570. The application program predictor 550 is configured to, e.g., identify applications that are likely to be launched on the user device 110. The actions predictor 560 is configured to, e.g., identify actions that a user is likely to perform via the user device 110. The contact predictor 570 is configured to, e.g., identify data related to contacts that the user will likely communicate with.

The interface 580 allows the intent detector 136 to communicate with, e.g., the user device 110, the server 130, and the network 120 to, e.g., receive variables and to send determined user intents.

It should be noted that the intent detector 136 described herein with respect to FIG. 5 is merely an example and is not limited to the particular architecture disclosed herein. An intent detector having more, less, or different engines or otherwise having different architecture may be utilized without departing from the scope of the disclosure.

It should be further noted that the prediction engine 540 is shown in FIG. 5 as being separate from the application predictor 550, the action predictor 560, and the contact predictor 570 merely for simplicity purposes and without limitation on the disclosed embodiments. The prediction engine 540 may include the application predictor 550, the action predictor 560, and the contact predictor 570 without departing from the scope of the disclosure.

In certain configurations the plurality of insighters 510, the insight aggregator 520, the contextual scenario engine 530, the prediction engine 540, the application predictor 550, the action predictor 560, the contact predictor 570, and the interface 580 may be realized as hardware component or components. Such a hardware component includes general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

FIG. 6 depicts an example flow diagram 600 illustrating an operation of the intent detector 136 based on sensor signals according to an embodiment. In an embodiment, the intent detector 136 includes the plurality of insighters 510₁ through 510_{O}, the insight aggregator 520, the scenario engine 530, the prediction engine 540, the application predictor 550, the action predictor 560, and the contact predictor 570.

The operation of the intent detector 136 starts when one or more of a plurality of sensors 111₁ through 111_{N} of the user device 110 collects a plurality of signals 601₁ through 601_{M} (hereinafter referred to individually as a signal 601 and collectively as signals 601, merely for simplicity purposes). The signals 601 are received by the server 130. Based on the collected signals 601, the plurality of insighters 2101 through 210_{O} are configured to generate a plurality of insights 602₁ through 602_{P} (hereinafter referred to individually as an insight 602 or collectively as insights 602, merely for simplicity purposes). Each insight 602 relates to one of the collected signals 601.

The insight aggregator 520 is configured to differentiate between the plurality of insights 602 generated by the insighters 510. The differentiation may include, but is not limited to, identifying common behavior patterns as opposed to frequent uses, thereby increasing the efficiency of the insights generation.

According to the disclosed embodiments, a common behavior pattern may be identified when, for example, a particular signal is received at approximately regular intervals. For example, a common behavior pattern may be identified when a GPS signal indicates that a user is at a particular location between 8 A.M. and 10 AM every business day (Monday through Friday). Such a GPS signal may not be identified as a common behavior pattern when the signal is determined at sporadic intervals. For example, a user occupation of the same location on a Monday morning one week, a Friday afternoon the next week, and a Saturday evening on a third week may not be identified as a common behavior pattern. As another example, a common behavior pattern may be identified when an accelerometer signal indicates that a user is moving at 10 miles per hour every Saturday morning. As yet another example, a common behavior pattern may be identified when a user calls a particular contact in the evening on the first day of each month.

The differentiated insights 602 are sent to a contextual scenario engine 530, to a prediction engine 540, or to both. The contextual scenario engine 530 is configured to generate one or more contextual scenarios 603 associated with the insights 602. In an embodiment, the contextual scenario engine 530 may be further configured to determine a user intent 604 of a user of the user device 110 based on the generated contextual scenarios. Generating contextual scenarios and executing actions respective thereof are described further herein below with respect to FIG. 7.

The prediction engine 540 is configured to predict future behavior of the user device 110 based on the insights 602. Based on the predicted future behavior, the prediction engine 540 may be configured to generate a prediction model. The prediction model may be utilized to determine actions indicating user intents that may be taken by the user in response to particular contextual scenarios. Further, the prediction model may include a probability that a particular contextual scenario will result in a particular action. For example, if user interactions used to generate the prediction model indicate that a user launched an application for seeking drivers 3 out of the last 4 Saturday nights, an action of launching the driver application may be associated with a contextual scenario for Saturday nights and with a 75% probability that the user intends to launch the application on a given Saturday night.

The prediction engine 540 may include or may be communicatively connected to an application program predictor (app. predictor) 550 for identifying application programs that are likely to be launched on the user device. The prediction engine 540 may further include an actions predictor 560 for identifying actions that a user is likely to perform on the user device 110. The prediction engine 540 may further include a contact predictor 570 used to identify data related to persons that a user of the user device 110 is likely to contact.

It should be noted that FIG. 6 is described with respect to received signals merely for simplicity purposes and without limitation on the disclosed embodiments. The insighters 510 may, alternatively or collectively, generate insights based on variables (e.g., environmental variables, personal variables, queries, or a combination thereof) without departing from the scope of the disclosure.

FIG. 7 depicts an example flowchart S320 illustrating a method for contextually determining user intent based on use of a user device (e.g., the user device 110) according to an embodiment. In an embodiment, the method may be performed by an intent detector (e.g., the intent detector 136) or by a server (e.g., the server 130). In another embodiment, the method performed by an agent (e.g., agent 115) operable in the user device.

At S710, variables related to a user device are determined. The variables may include, but are not limited to, environmental variables, personal variables, queries, combinations thereof, and so on. In an embodiment, the determined variables may be obtained from a database or from the user device (e.g., via an agent executed by the user device). In another embodiment, the determined variables may be based on one or more signals such as, e.g., sensor signals captured by sensors associated with the user device.

At S720, one or more insights are generated based on the variables. In an embodiment, S720 may further include generating a conclusion based on the insights, and so on. In a further embodiment, the conclusions may be generated based on past user interactions, user behavior patterns, or a combination thereof.

At optional S730, a weighted factor is generated respective of each insight. Each weighted factor indicates the level of confidence in each insight, i.e., the likelihood that the insight is accurate for the user's current intent. The weighted factors may be adapted over time. To this end, the weighted factors may be based on, for example, previous user interactions with the user device. Specifically, the weighted factors may indicate a probability, based on previous user interactions, that a particular insight is associated with the determined variables.

At S740, a context is generated respective of the insights and their respective weighted factors. The generated context may include, but is not limited to, one or more contextual scenarios. Generating contexts may be performed, for example, by matching the insights to insights associated with contextual scenarios stored in a contextual database (e.g., the contextual database 140). The generated context may be based on the contextual scenarios associated with each matching insight. In an embodiment, the matching may further include matching textual descriptions of the insights.

At S750, based on the generated context, a user intent is determined. The user intent may be determined based on a prediction model. In an embodiment, the prediction model may have been generated as described further herein above with respect to FIG. 3.

At S760, it is checked whether additional variables have been determined and, if so, execution continues with S710; otherwise, execution terminates. The checks for additional variables may be performed, e.g., continuously, at regular intervals, or upon determination that one or more signals have changed.

As a non-limiting example, a GPS signal is used to determine environmental variables indicating that the user is at the address of a supermarket on a Saturday morning. Based on the variables, an insight illustrating that the variable is related to a location and a conclusion that variables are in accordance with the user's typical behavior pattern is generated. The insight is further matched to insights stored in a contextual database to identify contextual scenarios associated thereto and a context is generated based on the contextual scenarios. The context indicates that the user intent is weekly grocery shopping.

It should be noted that the disclosed embodiments for determining the user intents, the contextual assumptions, and verifying the user intents can be performed exclusively by a user device (e.g., device 110) or by the server (e.g., server 130) using inputs received from the user.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing content based on executions of applications, comprising:
identifying a request to execute an application on a user device;
determining, based at least in part on the identified request, a user intent of a user of the user device;
querying, based on the user intent, at least one data source;
selecting, based on a response from the at least one data source, at least one content item for display on the user device; and
sending, to the user device, the selected at least one content item.

2. The method of claim 1, wherein the user intent is determined further based on at least one variable.

3. The method of claim 2, wherein each variable is any of: an environmental variable, and a personal variable.

4. The method of claim 3, wherein determining the user intent further comprises:
generating, based on the at least one variable, at least one context related to the user device, wherein the user intent is determined in part based on the at least one context.

5. The method of claim 1, further comprising:
generating, based on the user intent, at least one query for each of the at least one data source; and
receiving at least one content item from the at least one data source, wherein the selected at least one content item is selected from the received at least one content item.

6. The method of claim 1, further comprising:
determining a time pointer for displaying the selected at least one content item.

7. The method of claim 6, wherein the time pointer is determined at least in part based on the determined user intent.

8. The method of claim 6, wherein the time pointer indicates any of: a time before execution of the application, a time during execution of the application, and a time after execution of the application.

9. The method of claim 1, wherein selecting the at least one content item for display on the user device further comprises:
analyzing the determined user intent and the requested application, wherein the selection is further based on the analysis.

10. A non-transitory computer readable medium having stored thereon instructions for causing one or more processing units to:
identify a request to execute an application on a user device;
determine, based at least in part on the identified request, a user intent of a user of the user device;
query, based on the user intent, at least one data source;
select, based on a response from the at least one data source, at least one content item for display on the user device; and
send, to the user device, the selected at least one content item.

11. A server for providing content based on executions of applications, comprising:
a processing system; and
a memory, the memory containing instructions that, when executed by the processing unit, configure the system to:
identify a request to execute an application on a user device;
determine, based at least in part on the identified request, a user intent of a user of the user device;
query, based on the user intent, at least one data source;
select, based on a response from the at least one data source, at least one content item for display on the user device; and
send, to the user device, the selected at least one content item.

12. The server of claim 11, wherein the user intent is determined further based on at least one variable.

13. The server of claim 12, wherein each variable is any of: an environmental variable, and a personal variable.

14. The server of claim 13, wherein the server is further configured to:
generate, based on the at least one variable, at least one context related to the user device, wherein the user intent is determined in part based on the at least one context.

15. The server of claim 11, wherein the server is further configured to:
generating, based on the user intent, at least one query for each of the at least one data source; and
receiving at least one content item from the at least one data source, wherein the selected at least one content item is selected from the received at least one content item.

16. The server of claim 11, wherein the server is further configured to:
determine a time pointer for displaying the selected at least one content item.

17. The server of claim 16, wherein the time pointer is determined at least in part based on the determined user intent.

18. The server of claim 16, wherein the time pointer indicates any of: a time before execution of the application, a time during execution of the application, and a time after execution of the application.

19. The server of claim 11, wherein the server is further configured to:
analyze the determined user intent and the requested application, wherein the selection is further based on the analysis.
